(19) United States
(12) Patent Application Publication
(10) Pub. No.: US 2007/0120969 A1
(43) Pub. Date: May 31, 2007

(54) Audio visual communication system and method

(75) Inventors: Rich Gasper, Phoenix, AZ (US); Gianfranco Fiorio, Arlington, VA (US)

Correspondence Address: BRAD CLOSE;TIGHE PATTON, PLLC, 1747 PENN. AVE. NW, SUITE 300, WASHINGTON, DC, 20006-4604, US

(73) Assignee: Alpha Omega International

(21) Appl. No.: 11/511,722

(22) Filed: Aug. 29, 2006

Related U.S. Application Data
(60) Provisional application No. 60/717,269, filed on Sep. 15, 2005.
(60) Provisional application No. 60/776,184, filed on Feb. 23, 2006.

(51) Int. Cl. H04N 7/14

(52) U.S. Cl. 348/14.12

(57) ABSTRACT

An audio visual communication system and method that has a first user and at least one additional user. A computerized network, a first computerized device for the first user and a second computerized device for the second user. The computerized devices have a display, an input control, access to the computerized network and an audio and visual capturing apparatus. A link between the first device and the second device is established over the computerized network, and audio and visual data is transferred between the devices. The data is compressed before being sent and decompressed after being received. Both the data being sent by the devices and data being received by the devices are displayed on the devices. The first user sets a frame rate of the visual data and an overall data rate of the audio and visual data that the first device is sending over the computerized network.

This application claims priority from U.S. provisional patent applications 60/717,269 filed Sep. 15, 2005, and 60/77,6,184 filed Feb. 23, 2006, both entitled “Audio Visual Communication System and Method,” and both by Gasper, et al.

### BACKGROUND

Although great leaps have been made in telecommunications, a usable audio and visual communication method and system has yet to be achieved. What is needed is a system and method to make audio visual communication usable.

Other difficulties with the prior art also exist, some of which will be apparent upon further reading.

### SUMMARY OF THE INVENTION

The present invention provides for an audio visual communication system and method that has a first user and at least one additional user. Also, a computerized network, a first computerized device for the first user and a second computerized device for the second user. The computerized devices have a display, an input control, access to the computerized network and an audio and visual capturing apparatus. A link between the first computerized device and the second computerized device is established over the computerized network and audio and visual data is transferred between the computerized devices. The data is compressed before being sent and decompressed after being received. Both the data being sent by the computerized devices and data being received by the computerized devices are displayed on the computerized devices. The first user sets at least a frame rate of the visual data and an overall data rate of the audio and visual data that the first computerized device is sending over the computerized network.

In a particular embodiment a suggested optimization is given to the user for the frame rate of the visual data and an overall data rate. Also the at least one additional user controls sets at least the frame rate of the visual data and an overall data rate of the audio and visual data that the second computerized device is sending over the computerized network.

In other embodiments the first user sets at least the frame rate of the visual data and an overall data rate of the audio and visual data that the second computerized device is sending over the computerized network. Also the setting may be a request that the at least one additional user may accept or reject.

In another embodiment, the audio visual communication system and method uses cryptical compression.

In some embodiments the at least one additional user is a person. In still other embodiments, the computerized device is at least one of a computer, a PDA, a cell phone and a game consol. And in still other embodiments the display contain at least one of, the at least one additional user's data rates, the at least one additional user's maximum data rates, a time of the communications, local times, cost of communication, maximum bandwidth available on the computerized network, and other users available on the computerized network.

Additional features may also be included in the communications package. For example, a camera option, a vertical axis flip, or an image checker.

Other embodiments of the present invention also exist, which will be apparent upon further reading of the detailed description.

### BRIEF DESCRIPTION OF THE FIGURES

FIG. 1 illustrates a two-way display according to one embodiment of the present invention.

FIG. 2 illustrates a multi-way conference with additional widows for images and documents.

### DETAILED DESCRIPTION OF THE INVENTION

The present invention provides for an audio and visual (AV) communication over a computerized network for a plurality of users in a plurality of locations. Each user sends to the other users an AV data stream. Each user has a display on a computerized device which shows the visual portion of each of the other user's AV data stream as well as the visual portion of their own data stream that they are sending the other users. Therefore, each user has a display showing all of the users including themselves. The displays are compartmentalized on a single screen, although in some embodiments multiple screens can be used.

Each user can adjust the AV data stream that they are sending to the other user(s). The adjustments include frame rate controls and data rate controls. The frame rate controls the number of frames in a given period of time (frames/sec), while the data rate controls the total volume of data (e.g. kilobytes) that a user is sending out, and as a result they will know how much bandwidth they are using for the AV communication on the computer network. In some cases, optimal adjustments will be suggested which the user may then opt to use or use a default. In particular embodiments the user may set certain guidelines which are then optimized by the computerized device. For example, a user may request a minimum of 3 frames/sec and a maximum of 300 kb of data rate, and the AV data stream is optimized within these parameters; or a minimum of 10 frames/sec and a maximum of all available bandwidth.

Once a frame rate and data rate are set, the local AV software adjusts the quality of the image based on the remaining bandwidth available. The user sees the frame rate and quality of their image near instantaneously and can quickly make adjustments. Quality enhancing techniques that improve the quality of the image and sound may be used. For example, the software may recognize images that are stationary in the picture and therefore no image updating will be required for those sections. The data consumption that would have been used in that section of the screen can then be used for other portions of the screen. Other quality enhancing techniques will be apparent to one of ordinary skill in the art.

The available bandwidth in many cases can vary often. Therefore, particular embodiments of the invention give constant readouts of available bandwidth. Although in many embodiments the user is given the opportunity of constant control over the adjustments, the amount of available bandwidth can affect the adjustments that a user has selected. As a result, the user may be warned when bandwidth is no longer available with the selected adjustments, or the adjustments may be over-ridden. For example, a user that selected 10 frames/sec, at a drop in bandwidth has the frame rates drop to 8 and further adjustments will only allow for adjustments in the frame rate of up to 8 (although, at that time, a user may wish to select even lower frame rates to improve the image quality). The selected adjustments may be displayed on a user's display, both what is selected and what is actually obtained if the two are not the same, particularly when the bandwidth is quickly changing. This information may also be sent to the displays of the other users.

In some embodiments a user may control the data stream that they are receiving from the other user(s) in a similar manner. A user may adjust the AV data stream separately for each of the other users that are on the system, or they may have a global adjustment, that performs the same adjustments for each. The global adjustments may also have an averaging function, for example, instead of saying use 100 kb for each of the other users, a user instead may say use 500 kb total and divide it among the other users. Also, a user may select an option where the system selects the frame and data rate for them based upon available bandwidth and predetermined factors, like processor speed, traffic load over the computerized network etc.

When a user adjusts the AV data stream of another user, a control message (request) can be sent, over a computerized network, to that other user's system. That other user's system is in the meantime collecting local AV data for a future AV data stream that has maximum total bandwidth usage. This AV data is adjusted for based on what requests are being sent from the other user's computer, if the requests are granted. In some cases the request may be adjusted based on determined local parameters, or even denied. This embodiment is particularly useful when the other “user” is handicapped or not a particular individual, such as a group, area or animal.

Once the frame rate is established, the other user's system then adjusts the picture and in some cases sound quality based on the remaining available data rate.

An additional feature is the ability to flip an image about the vertical axis, essentially reversing the left and right as it appears on the display. This can be done by a viewer or a sender, for example any and/or all users can reverse their own image or any image that they are receiving. A particular use for this embodiment is when two users are observing on their displays the same virtual environment, with the communications images shown in compartmentalized windows. One user may point at an object in the virtual environment, but his pointing is actually flipped from the other user's perspective. With the use of the vertical axis flip, either the sender or the receiver (or both) can flip the image so the pointing goes to the intended target.

Yet another feature is an image checker where a user's camera displays a user's image, either continuously, as a clip or as a still, before the user sends their image to another user(s), or intermittently. This may be done automatically, or by use of a particular selection or button. With this feature a user can see what they will be sending before they send it. This is particularly helpful when the camera that captures a person's image is out of alignment with the screen that they are looking at, so that they cannot look directly at the camera and the screen at the same time.

In a related embodiment a user may select an avatar to represent them instead of their own live image.

Still another feature is a picture taker. This feature captures a still image and retains a copy of it. A user may take it of themselves, or may take it of the image they are receiving. In one embodiment, the image quality is improved for the picture. This image quality may be done at the sacrifice of frame rate and/or bandwidth. When one user wishes to take a picture of another user at a higher quality, this may require a request to the other user's system to enhance image quality and in some cases adjust the camera's perspective. The picture may then appear in the display of the user for whom it was taken, or it may alternately appear in a separate window.

In some embodiments the displays sizes can be changed or even hidden entirely. For instance, users may wish the display of themselves to be minimal, such as a picture on picture type appearance. This feature becomes particularly important when managing large numbers of displays.

In some cases a user(s) will have multiple cameras. In one embodiment the user will select for which camera they wish to have their image or information on, and may be able to freely switch between the two cameras. In still further embodiments, the user's own display screen can split between images of the various cameras, displaying multiple windows of information.

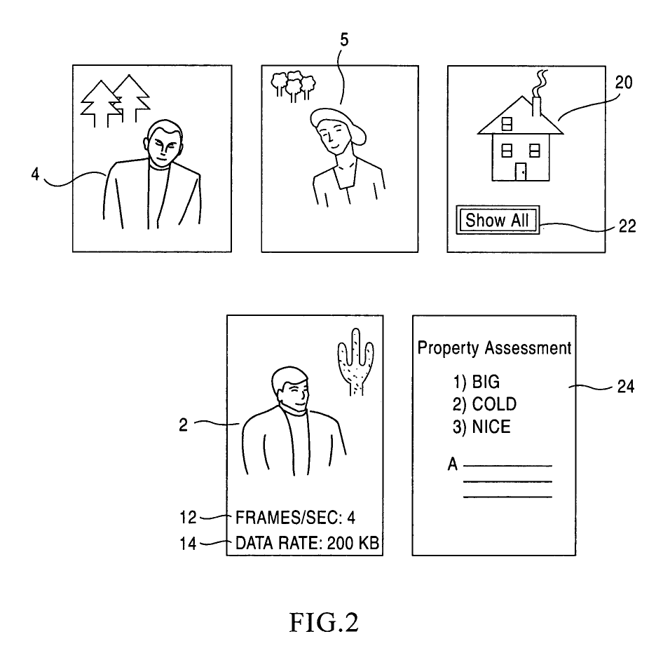

Referring to FIG. 2, one example of a multi user conference is shown. In this example a first user 2 is conferencing with at least two additional users 4,5. In this example, they are discussing a property 20 which is shown in an additional window, and may be a live data stream similar to the other user. Optionally, one of the users may have control over showing the property window 22, and may selectively show that window to one or more of the other users. An additional window 24 is present which may contain a text document that is made available to the other users. When more than two locations/users are being conferenced there is a need to duplicate/spilt the video and audio feeds through a server device, i.e. a reflector or similar device. Opening ports to a reflector that can single point out to an inter net can also bypass unnecessary firewall protection. This may also be accomplished by port trigger forwarding and other similar methods.

In all cases, the AV data is compressed and sent out over the computerized network to the other user(s). A user's system receives and decompresses the AV data stream, displaying and playing the AV as described. The other user's system is simultaneously performing the same functions.

Although security measures known in the art may be used, an additional security measure of the present invention is to use cryptic compression. The cryptical compression refers to a secret or unobvious way of compression, such that one of ordinary skill in the art would not be able to de-compress the compressed data without the provided de-compression software. For example, in order to decipher a compression, someone would have to know the compression structure being used down to the level of developed header values that represent compression schemes, and how other compression choices are made. Compression technology is known in the art, but some providers include Alpha Omega™ Inc, Microsoft™, and Real™.

In some embodiments, the AV data stream will also contain data information, such as frame rate, frame rate maximums, data rate and data maximums. In some embodiments the user's system further indicates a maximum data rate allowable. The maximum data rate allowable may also be sent to the other users. The user's system may also indicate an optimal frame rate. Within the system there is an outgoing and incoming frame buffer. The compression takes place between the outgoing frame buffer and the transmission control protocol (TCP) and decompression takes place between TCP and the incoming frame buffer.

A system that uses the present invention requires, record/play software which includes compression/decompression software, a visual display and audio speaker/mic, a computerized protocol enabled network connection, such as a phone, “Internet” and intranets, cable, cell/satellite phone. Examples of systems that may use the present invention include cellphones, pda, computers, game consoles, and similar devices. With a game console, an addition of a camera and microphone can be made to plug into existing ports. Then the AV system software can be launched in a manner similar to a game so that the game consol becomes a conferencing consol.

The adjustment interface may be varied, but in one embodiment comprises graphic linear bars with an adjustable tab. In addition, these adjustments may be displayed simultaneously with the rest of the images, or they may be on a separate page that may contain only the image that they are connected to. The audio and video may be separated into different streams and sent separately. As a result they may be manipulated and sent separately. In some cases, the picture and/or audio may be discontinued in favor of the other.

In order to help system-to-system compatibility, the programs controlling the AV communication system and method can be written in universal code. A example of universal code includes Assembler.

In some embodiments exclusively 2-way communication is used. That is, a single user-to-user link is established and two images are put on display. This 2-way communication may be established automatically with the sending of an initial message. For example, a first user calls a second user on a cell phone that has a display. As soon as the second user answers the 2-way communication of the present invention is initiated.

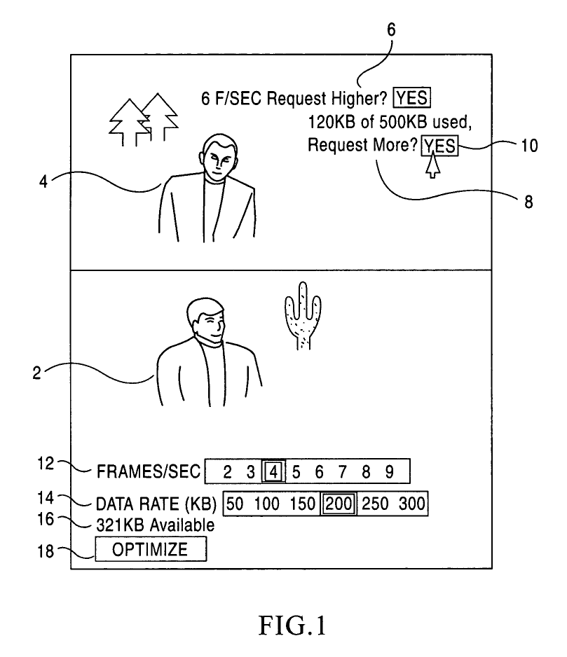

Referring to FIG. 1 an example of the present invention is illustrated. In this example a first user 2 sees himself on the bottom portion of a display screen and a second user 4 is shown on a top portion. The orientation of this may be changed, and in some applications, such as with desktop and laptop computers, only a fraction of the display screen may be dedicated to the AV communication method. The first user sees the second user, and in this embodiment is given a readout of the frame rates per second 6 as well as the overall data rate 8 which includes the maximum available. In this example the date rate is given as a “120 of 500” format, but could equally be displayed as a percentage or other mechanism. Also in this embodiment, the first user is given a choice of selecting or requesting a higher quality image 10 which may be accepted or ignored by the second user.

The first user 2 is also shown a display of the frame rate 12 and data rate 14 that he is sending, as well as the maximum available bandwidth 16, which may fluctuate constantly. The rates for the first user are displayed on a sliding bar, since the first user is allowed to adjust them constantly. In some embodiments this may be hidden, or brought up in a separate window. Also available is an optimize function 18 which will optimize the frame rate and image quality based on the available bandwidth. This optimize function may be the system default, and the user has to actively de-select to switch to manual.

In addition to the embodiment shown in FIG. 1, other applications may be running on the screen at the same time. For example, two users playing a cooperative video game may have the video game running on screen as well. Or two users going over the same spreadsheet, article, map, etc.

In some systems, such as the Internet, users typically try and obtain and use as much bandwidth as possible. However, there can be circumstances when bandwidth providers do not wish every user to maximize their bandwidth. In such circumstances, such as cell phone providers, maximum available bandwidths for video conferencing may be set to predetermined limits. This limit can also be upgradeable as a provider desires.

Available bandwidth can also have common fluctuations. In some cases a user's computer will track available bandwidth variations to determine an average maximum bandwidth available. The user can then be warned if the bandwidth that they are selecting is going above this average maximum.

In one embodiment the present invention provides for an audio visual communication system and method that comprises a first user and at least one additional user. A computerized network, a first computerized device for the first user and a second computerized device for the second user. The computerized devices have a display, an input control, access to the computerized network and an audio and visual capturing apparatus. A link between the first computerized device and the second computerized device is established over the computerized network and audio and visual data is transferred between the computerized devices, and the data is compressed before being sent and decompressed after being received. Both the data being sent by the computerized devices and data being received by the computerized devices are displayed on the computerized devices. The first user sets at least a frame rate of the visual data and an overall data rate of the audio and visual data that the first computerized device is sending over the computerized network.

In a particular embodiment a suggested optimization is given to the user for the frame rate of the visual data and an overall data rate. Also the at least one additional user controls sets at least the frame rate of the visual data and an overall data rate of the audio and visual data that the second computerized device is sending over the computerized network.

In other embodiments the first user sets at least the frame rate of the visual data and an overall data rate of the audio and visual data that the second computerized device is sending over the computerized network. Also the setting may be a request that the at least one additional user may accept or reject.

In another embodiment, the audio visual communication system and method uses cryptical compression.

In some embodiments the at least one additional user is a person. In still other embodiments, the computerized device is at least one of a computer, a PDA, a cell phone and a game consol. And in still other embodiments the display contains at least one of, the at least one additional user's data rates, the at least one additional user's maximum data rates, a time of the communications, local times, cost of communication, maximum bandwidth available on the computerized network, and other users available on the computerized network.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. An audio visual communication method comprising:
a first user;
at least one additional user;
a computerized network;
a first computerized device for said first user; and
a second computerized device for said additional user;
wherein said computerized devices have a display, an input control, access to said computerized network and an audio and visual capturing apparatus;
wherein a link between said first computerized device and said second computerized device is established over said computerized network and audio and visual data is transferred between said computerized devices, and wherein said data is compressed before being sent and decompressed after being received;
wherein both the data being sent by said computerized devices and data being received by said computerized devices are displayed on said computerized devices;
wherein said first user sets at least a frame rate of said visual data and an overall data rate of said audio and visual data that said first computerized device is sending over said computerized network.

2. The audio visual communication method of claim 1, wherein a suggested optimization is given to said user for said frame rate of said visual data and an overall data rate.

3. The audio visual communication method of claim 1, wherein said at least one additional user controls sets at least the frame rate of said visual data and an overall data rate of said audio and visual data that said second computerized device is sending over said computerized network.

4. The audio visual communication method of claim 1, wherein said first user sets at least the frame rate of said visual data and an overall data rate of said audio and visual data that said second computerized device is sending over said computerized network.

5. The audio visual communication method of claim 4, wherein said setting is a request that said at least one additional user may accept or reject.

6. The audio visual communication method of claim 1, wherein said audio visual communication method uses cryptical compression.

7. The audio visual communication method of claim 1, wherein said at least one additional user is a person.

8. The audio visual communication method of claim 1, wherein said computerized device is at least one of a computer, a PDA, a cell phone and a game consol.

9. The audio visual communication method of claim 1, wherein said display contain at least one of, said at least one additional user's data rates, said at least one additional user's maximum data rates, a time of the communications, local times, cost of communication, maximum bandwidth available on said computerized network, and other users available on said computerized network.

10. The audio visual communication method of claim 1, wherein audio visual communication method also includes at least one of, a vertical flip, a self image checker, and a camera selector.

11. The audio visual communication method of claim 1, wherein audio visual communication method also includes a picture taker, wherein quality is maximized for said picture taker.

12. The audio visual communication method of claim 1, wherein a user is given a global adjustment, whereby said global adjustment averages data rate being received from said additional users.

13. The audio visual communication method of claim 1, wherein the overall data rate is overridden at a drop in available bandwidth.

14. The audio visual communication method of claim 1, wherein visual data quality is maximized.

15. The audio visual communication method of claim 1, wherein said computerized network places an upper restriction on the maximum overall data rate.

16. The audio visual communication method of claim 1, wherein at lest one user is inanimate.

17. The audio visual communication method of claim 1, wherein additional computer programs can be joined into said audio visual communication. and appear as a separate windows.

18. An audio visual communication method comprising:
a first user;
a second user;
a computerized network;
a first computerized device for said first user; and
a second computerized device for said second user;
wherein said computerized devices have a display, an input control, access to said computerized network and an audio and visual capturing apparatus;
wherein a link between said first computerized device and said second computerized device is established over said computerized network and audio and visual data is transferred between said computerized devices, and wherein said data is compressed before being sent and decompressed after being received;
wherein both the data being sent by said computerized devices and data being received by said computerized devices are displayed on said computerized devices;
wherein the data being sent by said computerized devices are images of the users;
wherein said first user sets at least a frame rate of said visual data and an overall data rate of said audio and visual data that said first computerized device is sending over said computerized network.

19. The audio visual communication method of claim 18, wherein audio visual communication method also includes at least one of, a vertical flip, self image checker, camera selector, and picture taker.

20. The audio visual communication method of claim 18, wherein said computerized devices are cell phones.
